(19) United States
(12) Patent Application Publication
(10) Pub. No.: US 2012/0103863 A1
(43) Pub. Date: May 3, 2012

(54) BENEFIT DENIAL DEVICE WITH SWIVEL ATTACHMENT

(75) Inventors: Sergio M. PEREZ, Lake Worth, FL (US); Karen E. BELLUM-BOMBER, Boca Raton, FL (US)

(73) Assignee: SENSORMATIC ELECTRONICS, LLC, Boca Raton, FL (US)

(21) Appl. No.: 12/915,886

(22) Filed: Oct. 29, 2010

(51) Int. Cl. B65D 81/02; B23P 11/00

(52) U.S. Cl. 206/586; 29/428

(57) ABSTRACT

A product protection apparatus and method are provided. The product protection apparatus has an arm assembly, a first collar and a second collar. The arm assembly has a plane and is extendable in a first direction and a second direction opposite the first direction. The arm assembly has a first connection point and a second connection point. The first collar is rotatably coupled to the first connection point and is adapted to rotate about a first axis of the first connection point that is substantially orthogonal to the plane of the arm assembly. The second collar is rotatably coupled to the second connector and is adapted to rotate about a second axis of the second connection point that is substantially orthogonal to the plane of the arm assembly. The first and second collars are arranged to retain a product.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates generally to security devices and more specifically to a method and system for preventing the theft of products of different sizes using a secure, adjustable product protection device.

### BACKGROUND OF THE INVENTION

Shoplifting continues to be a major concern of retail stores. Particularly with regard to electronic and other high-priced items, retailers continue to try and find effective product theft deterrents. However, wrongdoers are constantly coming up with methods of circumventing the latest theft-prevention devices offered by retailers. For example, some retailers have introduced theft deterrent devices such as cables, also known as “spider wraps” that are wrapped around a product and that sound an alarm when there is an attempted to remove the product from the wrap before it has been purchased. Other “safer” or “keeper” devices house the product but require at least some additional labor for their application and removal. Retailers are seeking an easier solution that can effectively display their items for sale, prevent the unauthorized removal of items within the package, and decreases in-store labor for the application and removal of these protective devices.

Retailers have turned toward wrapping their products with material containing an audible and/or visual alarm. The wrap is designed to initiate an alarm when an unauthorized removal is attempted. However, wraps can detract from the appeal of the product thus resulting in possible loss of sales. Additionally, wraps are cumbersome to use, hard to physically manage, difficult to attach to items, and difficult to remove at the point-of-sale.

“Safer” or “keeper” products are devices that house items in order to provide a visual deterrent to would-be shoplifters. Safer allow a customer to view the product therein, but to provide enough protection so that a thief cannot access the product. Safers are typically designed for small, packaged goods. There are two types of safers, fixed safers and adjustable safers. Fixed safers retain products of one size and one shape. Although adjustable safers allow for size adjustments in order to accommodate differently-sized products, they do not have the capability to accommodate oddly-shaped products. In other words, while a typical safer can be adjusted in one dimension, i.e. its length, it does not have components capable of adapting to products with non-conventional shapes.

Currently, some safers require special detaching device at the Point of Sale (“POS”). However, it is desirable to have a single detacher at the POS for all security devices to decrease confusion by employees and to speed up customer check-out.

In addition to wraps and safers that are adjustable in only one dimension, other retailers use the old-fashioned method of preventing theft of their expensive products, namely, locking these products in a protective case behind a checkout counter. Unfortunately, this method requires a sales associate to access the items that are protected by a lock and, because of their location behind the counter or locked in a cabinet, render the item inaccessible to a prospective customer. Placing items behind lock and key in this fashion requires store personnel to access the item for the customer. If there is no store employee around to access the items, the item typically does not get sold, thus resulting in high inventory levels for the retailer, decreased revenue, and unsatisfied customers.

It is therefore desirable to provide an adjustable product protection device that can be adapted for different sized and shaped products, including products having non-conventional shapes, that does not obscure the manufacturer's logo and product description, provides a sufficient deterrent for would-be shoplifters, can be adjusted in multiple directions and dimensions and is easy for store employees to remove at the POS when a product is being legitimately purchased.

### SUMMARY OF THE INVENTION

The present invention advantageously provides a method and apparatus for retaining products, including oddly-shaped products by providing an adjustable arm apparatus with rotatable collars.

In accordance with one aspect, the present invention provides a product protection apparatus having an arm assembly, a first collar and a second collar. The arm assembly has a plane and is extendable in a first direction and a second direction opposite the first direction. The arm assembly has a first connection point and a second connection point. The first collar is rotatably coupled to the first connection point and is adapted to rotate about a first axis of the first connection point that is substantially orthogonal to the plane of the arm assembly. The second collar is rotatably coupled to the second connector and is adapted to rotate about a second axis of the second connection point that is substantially orthogonal to the plane of the arm assembly. The first and second collars arranged to retain a product.

In accordance with another aspect, the present invention provides a product protection apparatus. A first section has a first connection point. A second section is slidably engagable with respect to the first section and has a second connection point. A first collar is rotatably coupled to the first section at the first connection point, and the first collar is adapted to rotate about a first axis of the first connection point that is substantially orthogonal to a plane of the first section. A second collar is connected to the second section at a second connection point, and the second collar is adapted to rotate about a second axis of the second connection point that is substantially orthogonal to a plane of the second section. A lock retains the first section and the second section in a fixed position. The first collar and second collar adapted to receive portions of the product.

In accordance with yet another aspect, the present invention provides a method of securing a product within a product protection device in which the product protection device has an arm assembly, a first collar and a second collar. The arm assembly has a plane and is extendable in an inward direction and an outward direction opposite the inward direction. The arm assembly has a first connection point and a second connection point in which the first collar is rotatably coupled to the first connection point and is adapted to rotate about a first axis of the first connection point that is substantially orthogonal to the plane of the arm assembly and the second collar is rotatably coupled to the second connector and is adapted to rotate about a second axis of the second connection point that is substantially orthogonal to the plane of the arm assembly. The arm assembly is adjusted in at least one of the inward direction and the outward direction to allow positioning about the product. The first collar and the second collar are rotatably adjusted to secure the product therein upon inward adjustment of the arm assembly. The arm assembly is inwardly adjusted to secure the product within the first collar and the second collar.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a bottom perspective view of an adjustable product protection device constructed in accordance with the principles of the present invention;

FIG. 2 is a bottom view of the adjustable product protection device of FIG. 1;

FIG. 3 is a top perspective view of the adjustable product protection device of FIG. 1 with a rectangular product contained therein;

FIG. 4 is a transparent view of the adjustable product protection device of FIG. 1 showing the sliding track;

FIG. 5 is a top perspective view of the adjustable product protection device of FIG. 1 with an odd-shaped product retained therein;

FIG. 6 is a bottom perspective view of the adjustable product protection device of FIG. 1 with an odd-shaped product retained therein;

FIG. 7 is a bottom view of the adjustable product protection device of FIG. 1 with an odd-shaped product retained therein;

FIG. 8 is a bottom view of the adjustable product protection device of FIG. 1 with an odd-shaped product retainer therein;

FIG. 9 is a section view of the adjustable product protection device of FIG. 2 taken through section A-A;

FIG. 10 is an enlarged view of the locking mechanism of FIG. 9 in both an open and a locked position;

FIG. 11 is a bottom perspective view of multiple adjustable product protection devices used to retain one product; and

FIG. 12 is a top perspective view of multiple adjustable product protection devices used to retain one product.

### DETAILED DESCRIPTION OF THE INVENTION

Before describing in detail exemplary embodiments that are in accordance with the present invention, it is noted that the embodiments reside primarily in combinations of apparatus components and processing steps related to providing an adjustable arm assembly that is adjustable inward and outward in order to receive products of different lengths. A first and a second collar are connected to the arm assembly at respective connection points and adapted to swivel up to 360 degrees in either direction with respect to the axis of the connection point taken through the plane of the arm assembly. The collars can be adjusted in order to retain oddly-shaped products.

Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

One embodiment of the present invention advantageously provides a method and apparatus for providing a size and angle-adjustable receptacle for a product in order to prevent theft of that product while still allowing indicia on the product to be viewed. The term “product” as used herein refers to the actual product is being sold or the product in product packaging. The apparatus of the present invention includes a receptacle to retain the product, where the ends forming the receptacle can be adjusted outward or inward thus varying the size of the receptacle in order to accommodate differently sized and shaped products. The ends of the receptacle can also swivel up to 360 degrees. This allows oddly-shaped products or packaging to be retained in the receptacle. The receptacle includes a locking mechanism that locks the size of the receptacle to prevent their further movement until the lock is released. Multiple receptacles can be used in order to accommodate differently shaped and sized products. The result is a receptacle that can dynamically change its dimensions by movement and angle displacement of the ends of the receptacle. The front of the product remains uncovered in order to show the substantial front of the product, its name or identifying logo, or other indicia.

The present disclosure will be understood more fully from the detailed description given below and from the accompanying drawings of particular embodiments of the invention which, however, should not be taken to limit the invention to a specific embodiment but are for explanatory purposes.

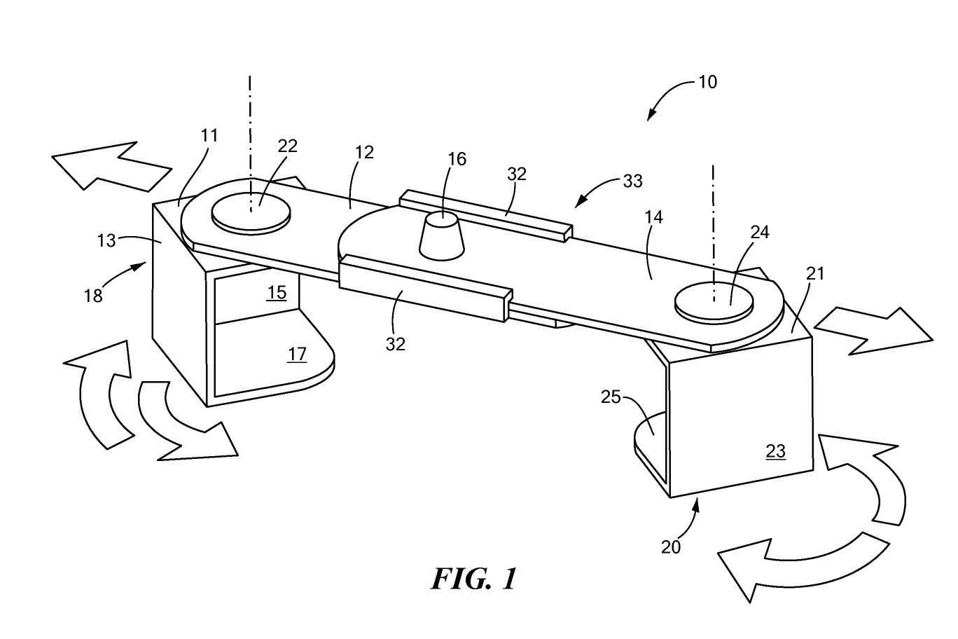

Referring now to the drawing figures in which like reference designators refer to like elements, there is shown in FIG. 1 an exemplary configuration of a product protection apparatus 10 according to an embodiment of the present invention. Apparatus 10 includes a first arm member 12 in a slidable relationship with a second arm member 14. Locking mechanism 16 locks first arm member 12 and second arm member 14 in place with respect to one another once each arm member has been adjusted to accommodate the length or width of a product. When locking mechanism 16 is released, first arm member 12 and second arm member 14 can again be slidably adjusted to widen or shorten the overall length of apparatus 10. First collar 18 is rotatably affixed to an end of first arm member 12 at connection point 22 and second collar 20 is rotatably affixed to an end of second arm member 14 at connection point 24. First collar 18 and second collar 20 can swivel up to 360 degrees about connection point 22 and connection point 24, respectively. Connection points 22 and 24 can be an axle upon which collars 18 and 20 are affixed. A securing point, such as a hub, can be snapped or welded to the axle and can be on the inside of collars 18, 20 in order to prevent tampering.

In one exemplary embodiment, retention members such as sliding rails 32 guide second arm member 14 as it travels along first arm member 12. Sliding rails 32 can be formed as part of first arm member 12 or second arm member 14 or be a separate component attached to either first arm member 12 or second arm member 14.

First arm member 12 and second arm member 14 are slidingly engageable with respect to one another and form arm assembly 33. In one embodiment, first collar 18 includes a top region 11, two side regions 13 and 15 respectively, and a bottom region 17. Similarly, second collar 20 includes a top region 21, two side regions (of which one side region 23 is shown in FIG. 1), and bottom region 25. In this embodiment, first collar 18 and second collar 20 are sized to receive portions of a product. The shape of each collar need not be restricted to what is depicted in FIG. 1. First collar 18 and second collar 20 may be of any shape that enables the secure receipt of a portion of a product. Each collar is adapted to swivel around the longitudinal axis of their respective connection points. The longitudinal axis is taken orthogonally with respect to the plane of arm assembly 33. The axis for each connection point is therefore taken orthogonally with respect to the plane of the corresponding arm, i.e., first arm member 12 and second arm member 14. First collar 18 can rotate in the direction of the curved arrows, therefore allowing first collar 18 to rotate 360 degrees in either direction with respect to the longitudinal axis of connection point 22. Second collar 20 is also adapted to rotate in either direction, as shown by the curved arrows in FIG. 1, with respect to the longitudinal axis of connection point 24. Of note, although the present invention is described with respect to the plane formed by arm assembly 33, this language is intended to refer to the length of the arm assembly and is not intended to limit arm assembly 33 to a flat shape. It is contemplated that arm assembly 33, and its constituent first arm member 12 and second arm member 14, can have a shape other than flat, e.g., rounded, semi circular, etc.

Thus, apparatus 10 can be adjusted linearly, by releasing locking mechanism 16 and then sliding first arm member 12 and/or second arm member 14 until a desired length is obtained. A product can be inserted within the space between first collar 18 and second collar 20. First collar 18 and second collar 20 can each receive a portion of a product, for example, an edge, a side, or a corner of the product. Advantageously, the product need not be conventionally shaped. First collar 18 and second collar 20 can be rotated up to 360 degrees in order to receive portions of the product. Once the desired orientation is obtained, locking mechanism 16 is locked and the orientation of first arm member 12, and second arm member 14 is maintained. As discussed below, it is also contemplated that locking mechanism 16 can be arranged to allow inward adjustment, i.e., shortening, of arm assembly 33 without having to unlock locking mechanism 16.

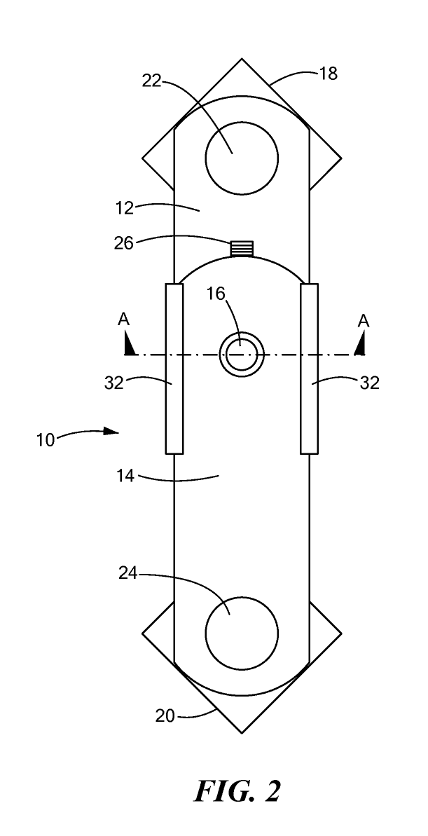

FIG. 2 is a bottom view of apparatus 10. First arm member 12 may include a sliding track 26 upon which second arm member 14 slides. Sliding track 26 can incorporate a series of teeth that receive a portion of locking mechanism 16 (discussed in greater detail below). Advantageously, when not in use, apparatus 10 takes up a small amount of space since second arm member 14 can be moved inward along sliding track 26 until apparatus 10 is in its shortest orientation. It is within the scope of the present invention to provide first arm member 12 and second arm member 14 of varying lengths and widths and the invention is not so limited in any way. Some stores that sell large bulky products can use longer versions of apparatus 10 to accommodate larger or longer products. Other stores, for example, that sell portable audio devices, batteries, DVD and CDs can choose to use shorter versions of apparatus 10. However, because apparatus 10 is adjustable in size, retailers need not be as concerned with protecting products of varying sizes. First arm member 12 and second arm member 14 can be adjusted, as described above, to accommodate products of different sizes and shapes.

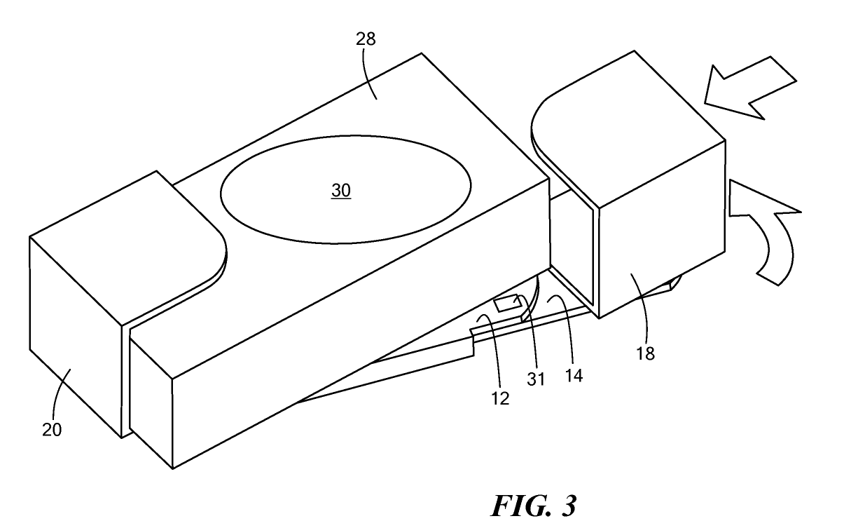

FIG. 3 illustrates apparatus 10 with a product 28 inserted therein. Product 28, in an exemplary embodiment, is rectangular in shape, and includes indicia 30, such as the product's name, directions for use, and the name of the product's manufacturer or supplier. Indicia 30 can be plainly seen since apparatus 10 provides an open area between first collar 18 and second collar 20. In use, a salesperson sizes the product 28 that needs to be protected, if necessary adjusts first arm member 12 and/or second arm member 14, inserts product 28 with indicia 30 visible, if necessary, adjusts first collar 18 and/or second collar 20, and then secures product 28 by locking first arm member 12 and second arm member 14 in the desired position. The first arm member 12 and/or the second arm member 14 of apparatus 10 can also be adjusted inward without disengagement of locking mechanism 16. Once retained, product 28 cannot be removed from apparatus 10 without destruction to apparatus 10 or product 28.

In another embodiment, a product identification device 31 such as an electronic article surveillance (“EAS”) tag or radio frequency identification (“RFID”) device may be included within apparatus 10. By affixing an EAS tag within apparatus 10, removal of product 28 within apparatus 10 without deactivation will sound an alarm. Further, inclusion of an RFID sensor within apparatus 10 can provide information to a store owner about the identity of product 28 contained within apparatus 10. Other alarming devices can be included within apparatus 10 including a sensor that will activate if product 28 is removed from apparatus 10.

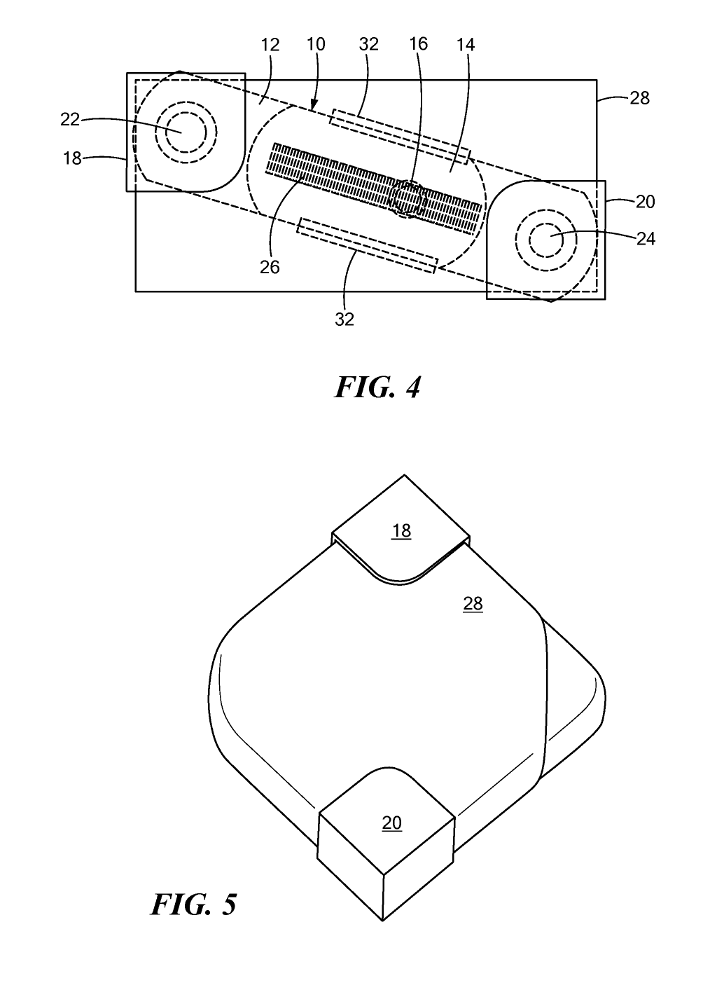

The method used to lock first arm member 12 and second arm member 14 so that they are retained at a desired position, will now be discussed. FIG. 4 illustrates a top view of apparatus 10 with product 28 secured therein. Sliding track 26 receives locking mechanism 16. Locking mechanism (discussed in greater detail below) can engage sliding track 26 to “lock” first arm member 12 and second arm member 14 at a specific location. When locking mechanism is released or retracted from within sliding track 26, second arm member 14 can be moved along sliding track 26 to a different location. In one embodiment, locking mechanism 16 includes metallic material within its housing. In one embodiment, when the metallic material is exposed to a magnetic field a spring that is also within the knob housing retracts and withdraws an extension member that had been engaged within sliding track 26, thus allowing first arm member 12 and/or second arm member 14 to be moved. Thus, a magnetic detaching unit can be used to “unlock” locking mechanism 16 in this manner. It is within the scope of the invention to include sliding track 26 in either first arm member 12 or second arm member 14.

FIG. 5 illustrates the apparatus 10 retaining an odd-shaped product 28. In this embodiment, first collar 18 and second collar 20 each retain a corner of product 28, allowing indicia 30 on the front of product 28 to be easily viewed. Because first collar 18 and second collar 20 can each swivel up to 360 degrees, apparatus 10 can be sized to retain oddly-shaped products 28. Once product 28 is retained within apparatus 10, if a salesperson feels that there is too much room between the collars 18 and 20 and product 28, he or she can easily adjust apparatus 10 by releasing locking mechanism 16 and readjusting first arm member 12 and/or second arm member 14 and their corresponding collars 18 and 20. Locking mechanism 16 can then again be locked to secure first arm member 12 and second arm member 14 and their corresponding collars 18 and 20 in the new position.

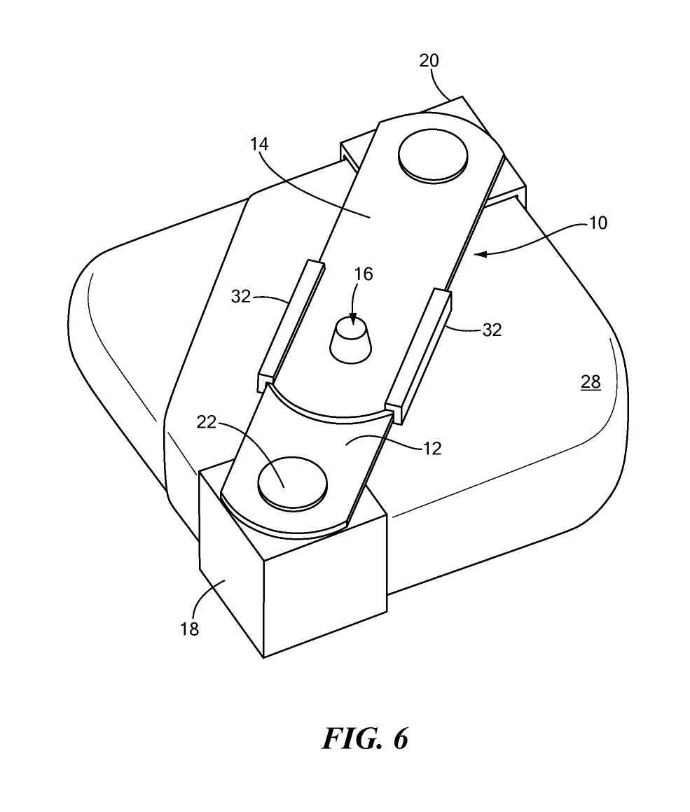

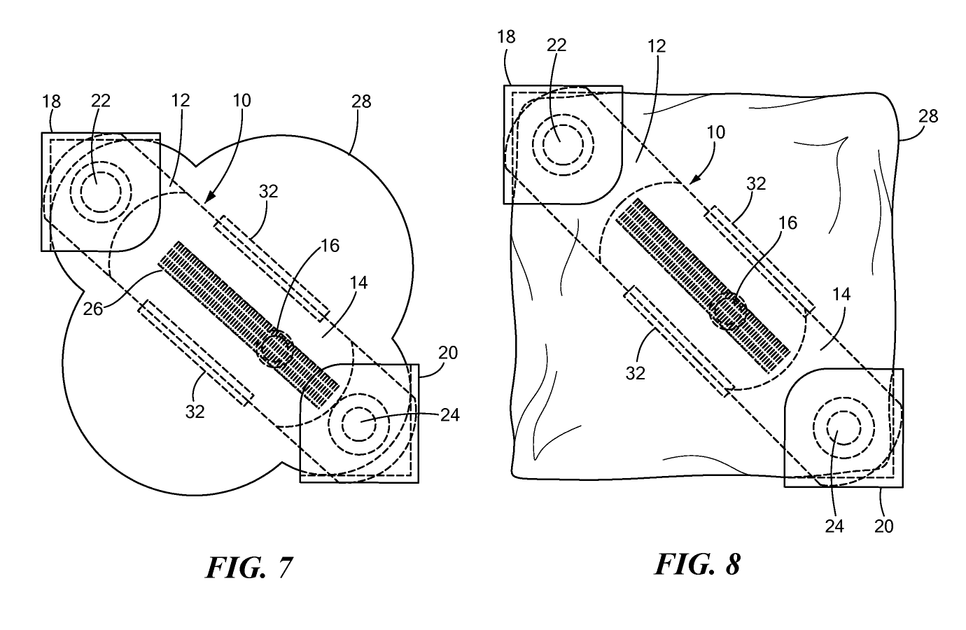

FIGS. 6-8 illustrate apparatus 10 retaining an odd-shaped product. Apparatus 10 is easily adapted to odd-shaped product 28 by extending, if necessary, first arm member 12 and second arm member 14, and maneuvering one or both of collars 18 and 20 in order to secure product 28 within apparatus 10. Collars 18 and 20 form a cavity into which a portion, such as a corner or edge of product 28 can be inserted. Because first collar 18 can swivel up to 360 degrees about connection point 22 and second collar 20 can swivel up to 360 degrees about connection point 24, an irregular-shaped product 28 can be retained within apparatus 10. Thus, the shape of product 28 need not be limited to a square or rectangle or have cornered edges, but can be of any shape that can retained with collars 18 and 20.

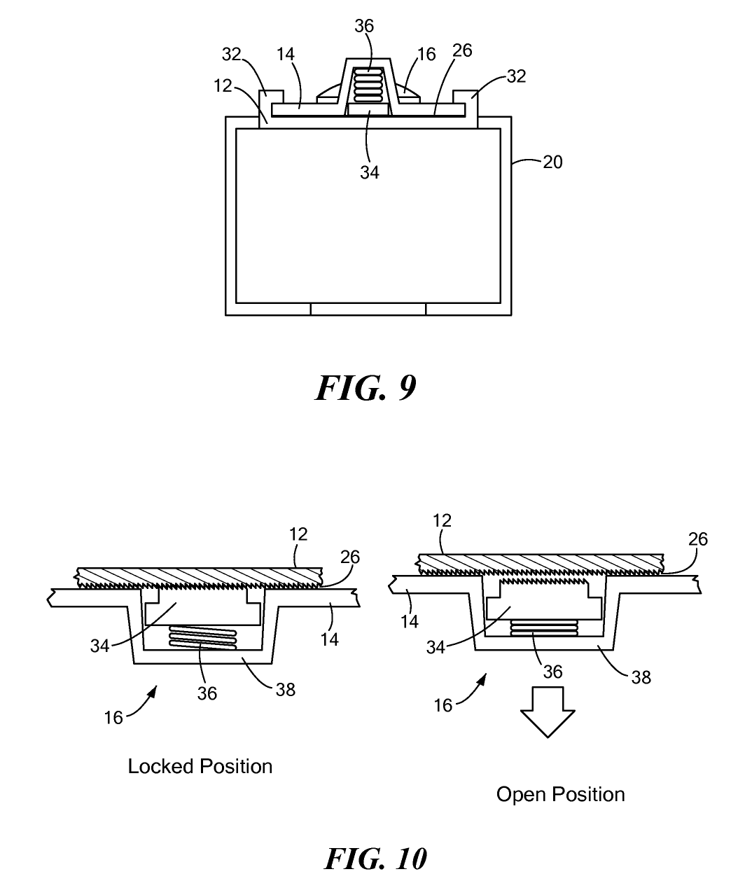

FIG. 9 is a section view of apparatus 10 viewed along the lines of the arrows in FIG. 2. Locking mechanism 16 includes a latch 34 and a spring 36 attached to latch 34. When locking mechanism 16 is in a “closed” position, latch 34 is extended into the path of track 26 of first arm member 12 thus preventing the movement of second arm member 14 with respect to first arm member 12. When spring 36 is compressed, latch 34 is retracted from within track 26 of first arm member 12 thus allowing second arm member 14 to move with respect to first arm member 12. Spring 36 may be retracted in a number of ways including manually or by the application of a magnetic field upon latch 34, which in one embodiment is made of a metallic material.

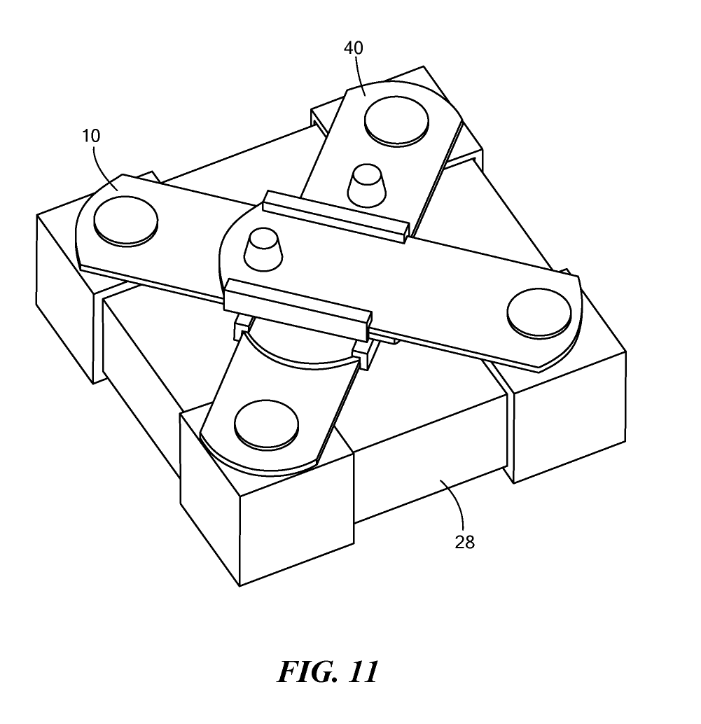

FIG. 10 illustrates locking mechanism 16 in both a locked position and an unlocked position. Locking mechanism 16 includes a recess 38 that includes spring 36 and latch 34. In one embodiment, recess 38 is formed out of second arm member 14, while in another embodiment, recess 38 is a separate component that interlocks with and protrudes from second arm member 14. When in a locked position, spring 36 extends and projects latch 34 within the path of first arm member 12. First arm member 12 can include track 26. Track 26 includes multiple teeth which receive latch 34 when spring 36 is in an extended position. The teeth of track 26 can be angled and oriented to allow inward adjustment of first arm member 12 and/or second arm member 14 without having to release locking mechanism 16. In one embodiment, latch 34 also includes a plurality of teeth that engage the teeth of track 26 when locking mechanism is in the locked orientation. In this locked orientation, latch 34 engages the teeth of track 26 and prevents further lateral extension between first arm member 12 and second arm member 14. In one embodiment, the teeth of track 26 are angled in one direction. Thus, when spring 36 is biased such that latch 34 biases is projected within the path of track 26 on first arm member 12, second arm member 14 can only be moved in one direction, i.e., inward, to more securely retain product 28. In this embodiment, once the teeth of track 26 are engaged with latch 34, second arm member 14 cannot be extended any further with respect to first to the angle of the teeth in track 26.

When spring 36 is compressed, latch 34 is retracted from track 26 thus allowing second arm member 14 to be extended. If latch 34 is made of a metallic material, application of a magnetic field upon latch 34 will retract latch 34, thus compressing spring 36 and releasing latch 34 from its engagement with the teach of track 26. A magnetic detaching unit can be used for this purpose. Thus, when a product 28 is brought to a cashier at a point of sale (“POS”), the cashier can use a magnetic detaching unit to release locking mechanism 16 by placing the magnetic detaching unit in proximity to locking mechanism 16. The magnetic detaching unit applies a magnetic field to locking mechanism 16 and latch 34 therein, which attracts latch 34, compresses spring 36 and retracts latch 34 from track 26. This allows first arm member 12 and second arm member 14 to be extended and product 28 removed from apparatus 10.

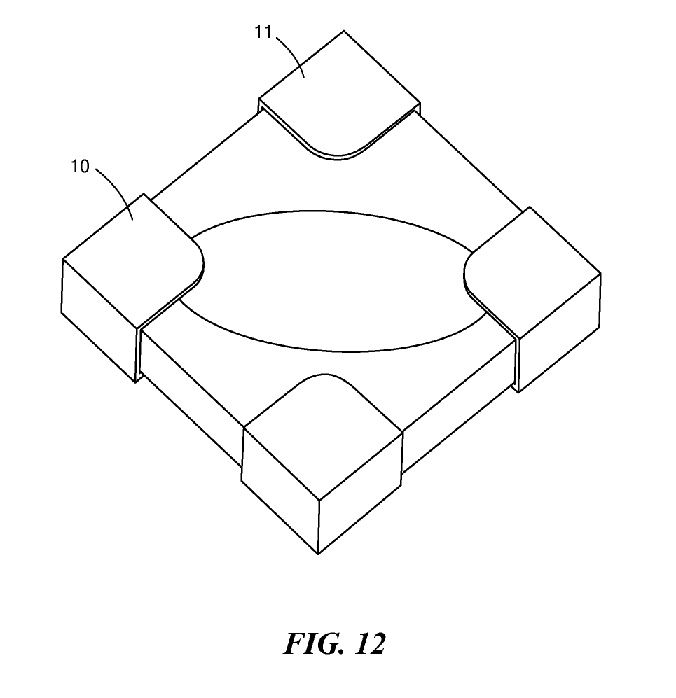

In another embodiment of the invention, as shown in FIG. 11 and FIG. 12, a first apparatus 10 and a second apparatus 40 can be combined to retain product 28. In one embodiment, second apparatus 40 resides beneath first apparatus 10, as shown in FIG. 12. Second apparatus 40 can also reside above first apparatus 10. In another embodiment, a bidirectional sliding track (not shown) can be used to allow for the extension of apparatus 10 and/or apparatus 40. In one embodiment, the locking mechanism in apparatus 10 can be unlocked in order to allow for the extension of apparatus 10. The locking mechanism on apparatus 40 can be unlocked to allow for the extension of apparatus 40. Thus, in this embodiment, one or both of the locking mechanisms can be employed to allow or restrict extension of their corresponding apparatus. It is contemplated that more than one locking mechanism can be used, as shown in FIG. 11. Alternately, a single locking mechanism that allows or restricts the movement of both apparatus 10 and apparatus 40 can be used. As shown in FIG. 12, the use of apparatus 10 and apparatus 40 provides four collars to retain each of the corners of the product.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A product protection apparatus, comprising:
an arm assembly, the arm assembly having a plane and being extendable in a first direction and a second direction opposite the first direction, the arm assembly having a first connection point and a second connection point;
a first collar rotatably coupled to the first connection point, the first collar adapted to rotate about a first axis of the first connection point that is substantially orthogonal to the plane of the arm assembly; and
a second collar rotatably coupled to the second connector, the second collar adapted to rotate about a second axis of the second connection point that is substantially orthogonal to the plane of the arm assembly, the first and second collars arranged to retain a product.

2. The apparatus of claim 1, wherein the arm assembly includes a first arm slidably engagable with a second arm, the first arm and the second arm slidably adjustable with respect to one another.

3. The product protection apparatus of claim 2, further comprising a lock to retain the arm assembly in a desired position.

4. The apparatus of claim 3, wherein the lock is operable in a first position to allow the first and second arms to be extended and in a second position that prevents the first and second arms from being extended.

5. The apparatus of claim 4, further comprising a track in slidable engagement with the lock, the track allowing the first and second arms to be extended when the lock is operable in the first position.

6. The apparatus of claim 5, the lock including a latch, wherein when the lock is in the second position the latch engages the track and when the lock is in the first position the latch is disengaged from the track.

7. The apparatus of claim 6, further comprising at least one of a radio frequency identification (“RFID”) device, an electrical article surveillance (“EAS”) tag, and an alarming device affixed to the arm assembly.

8. The apparatus of claim 6, the lock further comprising a spring biased against the latch when the lock is in the second position to project the latch into the track and inhibit extension of the housing.

9. The apparatus of claim 1, wherein the first collar and the second collar are adapted to rotate 360 degrees about the first axis and the second axis, respectively.

10. The apparatus of claim 6, wherein the latch is comprised of a metallic material.

11. The apparatus of claim 10, wherein the latch is retracted from the track by application of a magnetic field upon the latch.

12. The apparatus of claim 2, wherein the first arm further includes retention members to slidably retain the second arm.

13. A product protection apparatus comprising:
a first section having a first connection point;
a second section slidably engagable with respect to the first section, the second section having a second connection point;
a first collar rotatably coupled to the first section at the first connection point, the first collar adapted to rotate about a first axis of the first connection point that is substantially orthogonal to a plane of the first section;
a second collar connected to the second section at a second connection point, the second collar adapted to rotate about a second axis of the second connection point that is substantially orthogonal to a plane of the second section; and
a lock to retain the first section and the second section in a fixed position, the first collar and second collar adapted to receive portions of a product.

14. The apparatus of claim 13, wherein the lock is operable in a first position to allow the second section to slide with respect to the first section and in a second position that prevents sliding of the second section with respect to the first section.

15. The apparatus of claim 13, further comprising a track in slidable engagement with the lock, the track allowing the second section to move when the lock is operable in the first position.

16. The apparatus of claim 15, the lock including a latch, wherein when the lock is in the second position the latch engages the track and when the lock is in the first position the latch is disengaged from the track.

17. The apparatus of claim 15, the track comprising a plurality of teeth, the latch engaged with the teeth of the track when the lock is in the second position.

18. The apparatus of claim 16, the lock further comprising a spring biased against the latch when the lock is in the second position project the latch into the track and inhibit movement of the second section with respect to the first section.

19. The apparatus of claim 11, wherein the first collar and the second collar are adapted to rotate 360 degrees about the first axis and second axis, respectively.

20. A method of securing a product within a product protection device, the product protection device having an arm assembly, a first collar and a second collar, the arm assembly having a plane and being extendable in an inward direction and an outward direction opposite the inward direction, the arm assembly having a first connection point and a second connection point in which the first collar is rotatably coupled to the first connection point and is adapted to rotate about a first axis of the first connection point that is substantially orthogonal to the plane of the arm assembly and the second collar is rotatably coupled to the second connector and is adapted to rotate about a second axis of the second connection point that is substantially orthogonal to the plane of the arm assembly, the method comprising:
adjusting the arm assembly in at least one of the inward direction and the outward direction to allow positioning about the product;
rotatably adjusting the first collar and the second collar to secure the product therein upon inward adjustment of the arm assembly; and
inwardly adjusting the arm assembly to secure the product within the first collar and the second collar.
